(19) United States
(12) Patent Application Publication
(10) Pub. No.: US 2008/0063884 A1
(43) Pub. Date: Mar. 13, 2008

(54) METHOD FOR TREATING WOOD

(76) Inventors: Philip Leslie Robinson, Isle of Palms, SC (US); Jane Elizabeth Blasser, Mount Pleasant, SC (US); Michael Alan Lake, Mount Pleasant, SC (US); Humbert Thomas DelliColli, Hanahan, SC (US); Craig Richard McIntyre, Walls, MS (US)

Correspondence Address: MEADWESTVACO CORPORATION, Division and Technical Center - Law Dept., PO BOX 118005, CHARLESTON, SC, 29423-8005, US

(21) Appl. No.: 11/560,394

(22) Filed: Nov. 16, 2006

Related U.S. Application Data
(60) Provisional application No. 60/825,283, filed on Sep. 12, 2006.

(51) Int. Cl. B27K 3/15; B05D 3/12; B05D 3/02; B05D 1/18

(52) U.S. Cl. 428/541; 427/440; 427/372.2; 427/351

(57) ABSTRACT

The present invention relates to a process for treating wood and other cellulosic materials to render the resistance to wood attacking organisms, such as termite, fungi and insects. More particularly, the present invention relates to a process for treating wood with borate preservatives which contain at least one boron-containing component and at least one organic component capable of retaining impregnated borate inside the treated wood even upon contact with water. The organic borate-retaining components are lignin-based materials, alcohol-based materials, protein, and wood extracts.

This non-provisional application relies on the filing date of provisional U.S. Application Ser. No. 60/825,283, filed on Sep. 12, 2006, having been filed within twelve (12) months thereof, which is incorporated herein by reference, and priority thereto is claimed under 35 USC § 1.19(e).

### FIELD OF INVENTION

The present invention relates to a process for treating wood and other cellulosic materials to render the resistance to wood attacking organisms, such as termite, fungi and insects. More particularly, the present invention relates to a process for impregnating wood and other cellulosic materials with a borate preservative, in such a manner that the borate wood preservative is leach-resistant when the wood is in contact with water, thereby allowing its use for exterior applications.

### BACKGROUND OF THE INVENTION

Copper chrome arsenate (CCA), a leach-resistant wood preservative known for exterior application, is recently banned because of the toxic nature of arsenic and chromium. Since then, there has been a continuing effort to develop suitable alternative systems. A number of alternative, non-arsenical pesticidal treatments containing heavy metals (primarily copper) have been proposed. For example, U.S. Pat. No. 4,929,454 teaches the treatment of wood with a mixture of a copper compound and a quaternary ammonium compound. This technology has been commercialized under the name ammoniated copper quaternary amine (ACQ). It has excellent insect resistance, but it is considerable more costly than CCA, and it has a tendency to promote the growth of white mold on the wood surface. Furthermore, ACQ-treated wood may exhibit corrosion problems with most metal fasteners when the treated wood is placed into service. Special fasteners having high corrosive resistance are required for the ACQ treated-wood, causing an additional cost of using ACQ-treated wood for construction. Furthermore, there has been increasing concerns on the toxicity and environmental impact of wood preservative containing heavy metals.

Borate has been used as wood preservative for more than 50 years, since it is effective against most wood destroying organisms such as fungi, termite and wood-boring beetles. Furthermore, borate has a low acute mammalian toxicity and low environmental impact. Borate has been considered as an excellent candidate for the CCA replacement for wood preservative application. However, the well-known disadvantage of borate wood preservative is that borate is readily soluble in water, and easily leaches out of the treated wood upon contact with water. As a result, the use of borate preservative is limited to the treated wood for interior applications.

Several methods have been used to prevent the leaching of impregnated borate preservative from the treated wood. U.S. Pat. No. 2,194,827 uses solubilized metal such as zinc and copper to fix borate in wood. This method requires high concentration of ammonia to solubilize such metals and borates, resulting in excessive ammonia volatility and noxious fumes that is undesirable for large scale preparation. U.S. Pat. No. 6,896,908 addresses the ammonia off-gas issue by dissolving a high concentration of copper and/or zinc metal fixative agent in an aqueous solution of ammonia, volatile organic acid and ammonium salts. The combination of a volatile organic acid and ammonia provides a high rate of metal dissolution without requiring excessive levels of ammonia in solution, and the ammonium salt reduces the level of free ammonia needed for dissolution of metals. U.S. Pat. No. 5,207,823 discloses copper borate and/or zinc borate in combination of amine as a leach-resistant borate wood preservative. PCT Patent No. 95/27,600 teaches the use of nitrite to improve fixation of preservatives in wood, when the preservatives contains one or more copper and/or zinc salts of weak acid, and optionally boric acid and quaternary ammonium salt. U.S. Pat. No. 6,146,766 discloses the use of water soluble sodium silicate/borax mixture wherein the impregnated silicate component can be polymerized to reduce its water-solubility, thereby decreasing the leaching rate of water-soluble preservative from the treated wood. U.S. Pat. No. 6,508,869 uses amine oxide to improve leaching resistance of boron preservatives from the treated wood. In U.S. Pat. No. 5,087,457, polyammonium salts formed through the reaction of diamine and dihalide, are used in combination with borate to reduce leaching rate. However, the problem with these methods is that even the most water-insoluble borates, boric esters, and borate complexes will, on prolonged contact with water, hydrolyze to form boric acid which will leach out of the wood.

It is an object of the present invention to provide borate wood preservatives that not only enhance boron retention in the treated wood or other cellulosic materials, but also minimize toxicity and environmental impact. More particularly, it is an object of the present invention to provide a borate wood preservative containing no heavy metal, thereby eliminating the concerns on the toxicity and environmental impact of heavy metals such as chromium, zinc and copper.

It is another objective of the present invention to provide borate wood preservatives that use naturally-occurring materials to retain the impregnated boron inside the treated wood.

It is another objective of the present invention to provide a process for treating wood or other cellulosic materials with borate preservatives having improved boron retention that can be readily done using the equipment and process commonly available and known for impregnation of typical wood preservatives such as CCA.

Another object of the present invention is to provide a method for making wood resistant to damage caused by soil microbes and/or insects by treating the wood with borate preservatives having enhanced boron retention.

It is a further object of the present invention to provide treated wood with enhanced boron retention that can be used for exterior applications.

Other objects, features and advantages of the present invention will become apparent from the following detailed description.

### SUMMARY OF THE INVENTION

The objects of this invention are met by a process of treating wood with borate preservatives which contain at least one boron-containing component and at least one organic component capable of retaining impregnated borate inside the treated wood even upon contact with water. The organic borate-retaining components are lignin-based materials, alcohol-based materials, protein, and wood extracts.

### BRIEF DESCRIPTION OF THE DRAWINGS

FIG. 1 is a graph showing the percentage of boron retention at different time intervals under the accelerated weathering conditions for the treated boards having lignin-based materials as borate-retention components.

FIG. 2 is a graph showing the percentage of boron retention at different time intervals under the accelerated weathering conditions for the treated boards that are obtained from a two-step treatment process using different borate-retaining components: tannic acid; propylene glycol; corn zien protein, unsulfonated lignin, and wood extract from kraft spent pulping liquor.

FIG. 3 is a graph showing the percentage of boron retention at different time intervals under the accelerated weathering conditions for the treated boards that are from a one-step treatment process using different borate-retaining components: polyvinyl alcohol, tannic acid; hexanediol, wood extract from aged pine stump, and wood extract from kraft spent pulping liquor.

### DESCRIPTION OF THE INVENTION

The following detailed description illustrates embodiments of the present invention; however, it is not intended to limit the scope of the appended claims in any manner. It is to be understood that changes and modifications may be made therein as will be apparent to those skilled in the art. Such variations are to be considered within the scope of the invention as defined in the claims.

The advantages and purposes of the invention will be set forth in part in the description which follows, and in part will be obvious from the description, or may be learned by practice of the invention.

The borate preservatives of the present invention offer several benefits. They contain no heavy metals such as zinc, copper or chromium; therefore, they are more environmental friendly than the currently available CCA alternatives. They readily penetrate into wood and retain in the treated wood for a prolong period of time even after exposure to rigorous leaching conditions such as those for exterior applications. They contain low level of ammonia, thus avoiding the corrosion of metals in contact with the treated woods such as metal fasteners. Furthermore, the invention borate preservatives do not leave unsightly residue on the surface of the treated wood, typically observed with other CCA alternative.

A method of the present invention for producing wood that is resistant to insects and soil microbes, comprises the step of impregnating wood with a borate preservative, wherein the borate preservative comprises:

(a) at least one boron-containing component, and

(b) at least one borate-retaining component,

wherein the initial borate preservative level in the treated wood was from about 5% to 20% dry solids to the board weight, and the weight ratio of boron-containing component to the borate-retaining component was from about 1:3 to 1:10.

Wood which is suitable for use in the present invention may be of any species suitable for construction. Preferred woods include pine, fir, spruce, and hemlock. It is preferred that the wood employed in the present invention be a wood part. In the context of the present invention the term “wood part” relates to any wooden article that used in construction, particularly those articles that are subject to outdoor exposure (such as decking, facia boards, exterior grade plywood, construction elements for outdoor furniture or playground equipment, fencing, and the like).

Boron-containing component suitable for use in the present invention include, but are not limited to, boric acid, boric oxide, diboron tetrahydroxide, borane, ammonium borate, and alkali metal borates such as sodium borate, sodium metaborate, sodium tetraborate and disodium octaborate. Organic boron compound can also be used for the present invention. Examples of organic boron compound are, but not limited to, (2-methyl-2,4-pentanediol)monoborate, triethanediol diborate, tri-(2,3-dimethyl-2,3-butanediol)diborate, tri-(2,5-dimethyl-2,5-hexanediol)diborate, tri-(2,6-dimethyl-4-heptanol)borate, triethanolamine borate and tri-isopropanolamine borate.

As used herein the term “biocidally effective” means the minimum amount of borate necessary to kill the targeted insects or soil microbes. A boron level of approximately 350 ppm is required to provide wood with resistance to fungus and common subterranean termites. For resistance against Formosan termites, a minimum of 700 ppm of boron is required. It is well within the ability of those skilled in the art to utilize the method of the present invention to produce wood that is impregnated with a desired biocidal level of borate.

Mature, and in some instances juvenile, southern yellow pine sapwood board was used for the study of borate preservative retention. The invention borate preservative comprised at least one boron-containing component and at least one borate-retaining component, and it was impregnated into board from about 5% to 20% dry solids to the board weight, preferably from 10% to 20%, and more preferably from 15% to 20%. The weight ratio of boron-containing component to the borate-retaining component was from about 1:1 to 1:15, preferably from about 1:4 to 1:10. Two boron-containing components were investigated: boric acid and disodium octaborate tetrahydrate (DOT). Four types of borate-retaining components were used: lignin-based materials, alcohol-based materials, protein and wood extracts.

Boards were treated with the invention borate preservative using one-step process and two-step processes. For one-step treatment process, board was treated with liquid containing boron-containing and borate retaining components. (Table 1) For two-step treatment process, board was first treated with borate-retaining component, air-dried for a minimum of one week, and finally treated with boron-containing component. (Table 2)

TABLE 1
One-step Treatment Process

| | | Amount of Boron in the Board | | |
|---|---|---|---|---|
| | | | | % Retention |
| | Boron | | 14-week | after |
| Boron Retaining | Containing | Initial | weathering | 14-week |
| Component | Component | (ppm) | (ppm) | weathering |
| Propylene glycol | Boric acid | 5347 | 1604 | 30% |
| Tannic Acid | Boric acid | 7254 | 4425 | 61% |
| Corn Zein Protein | Boric acid | 2683 | 724 | 27% |
| Unsulfonated Lignin | Boric acid | 1328 | 478 | 36% |
| Wood extract from | DOT | 3529 | 2470 | 44% |
| kraft spent pulping | | | | |
| liquor | | | | |

| | | | |
|---|---|---|---|
| Control - Boric acid only | 3963 | 277 | 7% |
| Control - DOT only | 3696 | 222 | 6% |

After treating board with the preservative, the treated board was then placed under an accelerated weathering conditions simulating rainfall volumes of 90 inches per day, using a 24 hour-cycle water spray consisting of 3 hours of water spray, 3 hours of drying, 3 hours of water spray and 15 hours of drying. The treated board was subjected to these accelerated weathering conditions for 14 weeks which equaled to a total of 8,820 inches of rain for an entire period. The sample of treated board was taken each week for the measurement of boron content. The board treated with either only boric acid or DOT was included in the accelerated weathering condition test along with the boards treated with the invention borate preservative as a control. The inductive couple plasma (ICP) device was used to measure the content of boron in the board before the treatment, and after every week of accelerated weathering. The retention of boron as a percentage of the initial impregnated boron level was calculated, and compared to those of the control board.

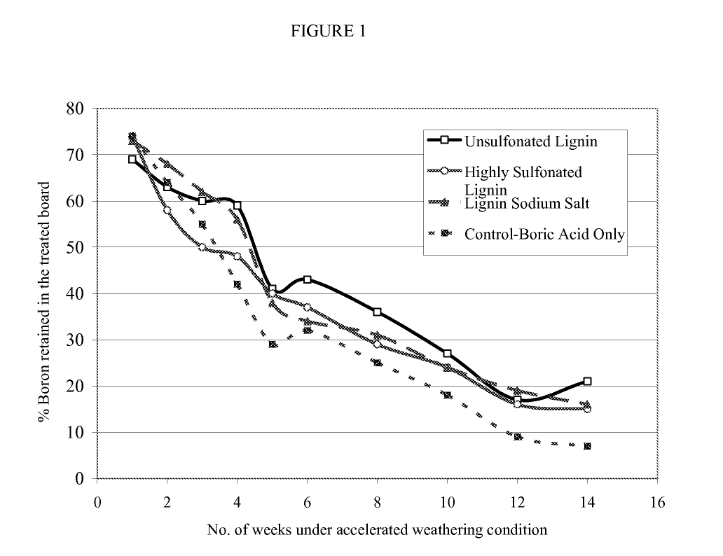

Several lignin-based materials from the kraft pulping process on southern yellow pine were used as the borate-retaining components. Examples were unsulfonated lignin, highly sulfonated lignin, and sodium salts of lignin. The 14-week accelerated weathering result showed that lignin-based materials enhanced the borate retention in the treated wood, and unsulfonated lignin provided superior borate retention to sulfonated lignin and sodium salt of lignin. (FIG. 1, Table 2)

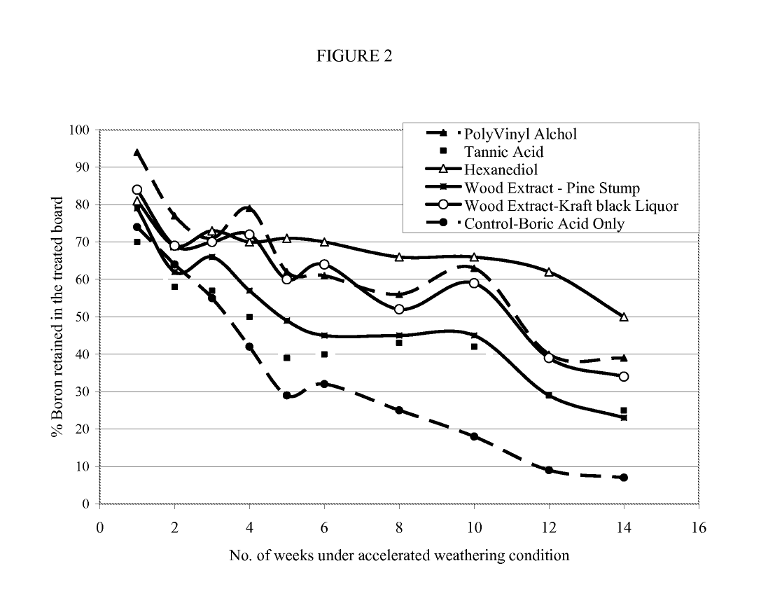

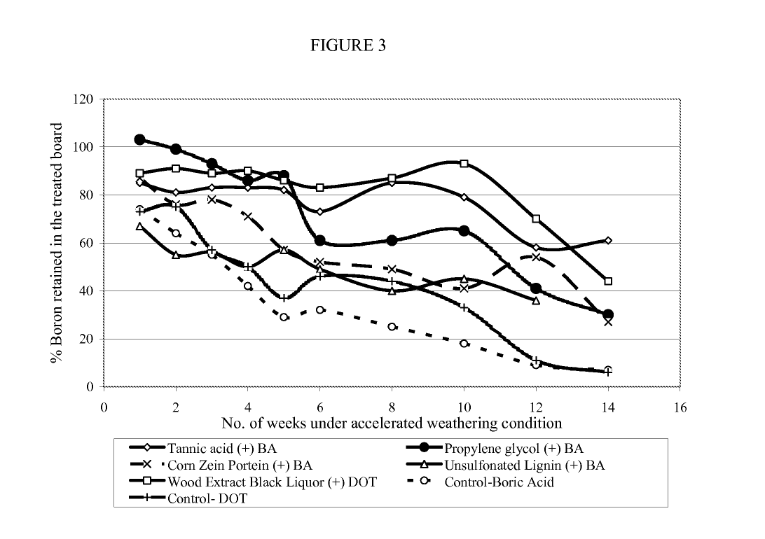

Examples of alcohol-based materials used as the borate-retaining components were polyvinyl alcohol, tannic acid, 2-ethyl-1,3-hexanediol, and propylene glycol. Polyvinyl alcohol, tannic acid, and 2-ethyl-1,3-hexanediol were applied to the board using two-step treatment process, in which the alcohol-based material was applied to the board first, followed by the boron-containing component. Hexanediol showed significant improvement in boron retention, approaching 50% of the initial impregnated boron after 14 weeks under accelerated weathering conditions, compared to only 7% for the control board treated solely with boron-containing component. (FIG. 2, Table 2) When propylene glycol was used as borate-retaining component, one-step treatment process was applied. (FIG. 3, Table 1) The boron retention increased when propylene glycol was used as a borate-retaining component, reaching 30% retention.

TABLE 2
Two-step Treatment Process

| | | Boron | Amount of Boron in the Board | | |
|---|---|---|---|---|---|
| | | Containing | | 14-week | % Retention |
| Boron Retaining Component | | Component | Initial | weathering | after 14-week |
| (1^{st} Treatment) | | (2^{nd} Treatment) | (ppm) | (ppm) | weathering |
| Lignin- | Unsulfonated lignin | Boric Acid | 3198 | 672 | 21 % |
| based | Highly sulfonated | Boric Acid | 3859 | 579 | 15% |
| material | lignin | | | | |
| | Sodium salts of a | Boric Acid | 3349 | 536 | 16% |
| | medium molecular | | | | |
| | weight lignin | | | | |
| Alcohol- | Fully hydrolyzed | Boric Acid | 1618 | 631 | 39% |
| based | polyvinyl alcohol | | | | |
| material | Tannic Acid | Boric Acid | 4401 | 1100 | 25% |
| | 2-Ethyl-1,3- | Boric Acid | 2919 | 1460 | 50% |
| | hexanediol | | | | |
| Wood | from aged pine stump | Boric Acid | 3034 | 698 | 23% |
| Extract | from kraft spent | Boric Acid | 2487 | 846 | 34% |
| | pulping liquor | DOT | 1643 | 608 | 37% |
| Control | None | Boric Acid | 3963 | 277 | 7% |
| | None | DOT | 3696 | 222 | 6% |

Corn zein, a protein derived from corn gluten meal, was evaluated as a borate-retaining component. Due to its water insolubility, corn zein was solubilized in propylene glycol prior to the board application. A one-step treatment was performed to impregnate a propylene glycol solution of corn zein and boric acid into the board. The treated board having corn zein protein showed improved boron retention after 14-week acceleration weathering test, although it was not as effective in retaining boron as alcohol-based materials. (FIG. 3, Table 1)

Wood extract generally contains organic acids, lignin, hemicellulose, terpenes, natural wax, sodium salts, and several other minor organic ingredients. Two sources of wood extracts were used in the study: aged pine wood stump and kraft spent pulping liquor. In cases where wood extract was insoluble in water, it was dissolved in toluene solvent prior to the board application. After impregnation of wood extract and evaporation of toluene, the treated board was impregnated with boron-containing component. When the wood extracts from aged pine stump and kraft spent pulping liquor were used, the boron retention in the treated wood increased. The wood extract from kraft spent pulping liquor showed much higher efficiency in retaining boron than the wood extract from aged pine stump. After 14 weeks of the accelerated weathering, the treated boards containing kraft spent pulping liquor extract showed boron retention of about 34% compared to about 23% for boards containing aged pine stump extract. (FIG. 2, Table 2) When the wood extract from kraft spent pulping liquor was used in combination with boron-containing compound for the one-step process, the boron retention increased to about 44% after the 14 weeks of accelerated weathering conditions. (FIG. 3, Table 1)

In the methods of the present invention, it is preferred that the wood be immersed in the liquid containing boron component and/or borate-retaining component at ambient temperature. Common solvents known in arts such as toluene can be used as liquid medium, but aqueous is most preferred for the present invention. The liquid containing boron component can be either a solution obtained from dissolving boron components directly into an aqueous phase, or an emulsion obtained from homogenizing an aqueous phase and an oil phase with an emulsifier.

Where desired, the method of the present invention may be practiced at a neutral pH in the range of about 6.0 to about 10.0 to minimize potential corrosion problems with fasteners (such as nails, screws, and the like).

The impregnation of board with the invention borate can be done by any method known to one of ordinary skill in the art including, but are not limited to, pressure treating, vacuum impregnating, soaking, spraying, painting, brushing, washing, dipping, rubbing, mixing, blending, infusion and the like. Furthermore, the impregnation of board can be carried out at atmospheric pressure, but it is more advantageously carried out at elevated pressure. “Loading” is a synonym for the absorption of the impregnating liquid dispersion or liquid solution by the wood and is—in the context of the present invention—also used for the respective technical impregnating process of immersing (and, preferably, applying pressure and subsequent relieving of the pressure). Methods of treating wood with chromated copper arsenate solutions and similar pesticidal mixtures at elevated pressures are well known in the art. The same equipment (e.g., pressure vessels) employed in such currently-used pesticide treatment methods can be readily adapted to the treatment of wood with the liquid of the present invention. Indeed, the wood may be immersed in any suitable vessel which can be closed to generate the given excess pressure for the loading. Likewise, pressures which are typically used for the production of chromated copper arsenate treated wood are suitable for use in the present method. A preferred pressure range is from about 50 psi to about 200 psi. After treating with borate preservative, the treated board is dried under ambient condition, although kiln drying or other heat treatment may be used to help fix the preservative components in the wood.

One preferred embodiment of the present invention comprises the steps of:
(i) immersing wood in a liquid containing a borate preservative, wherein the borate preservative comprises:
   (a) at least one boron-containing component, and
   (b) at least one borate-retaining component,
      wherein the borate preservative level in the treated wood was from about 5% to 20% dry solids to the board weight, and the weight ratio of boron-containing component to the borate-retaining component was from about 1:3 to 1:10;
(ii) loading the immersed wood with the liquid under excess pressure for a period of time sufficient to impregnate the wood with a biocidally effective level of borate introduce a biocidally effective level of borate, thereafter relieving the excess pressure; and
(iii) removing the wood from the liquid.

Another preferred embodiment of the present invention comprises the steps of:
(i) immersing wood in a liquid containing at least one borate-retaining component;
(ii) loading the immersed wood with the liquid under excess pressure;
(iii) removing the wood from the liquid;
(iv) air-drying the wood for at least one week;
(v) immersing the wood in a liquid containing at least one boron-containing component;
(vi) loading the immersed wood with the liquid under excess pressure for a period of time sufficient to impregnate the wood with a biocidally effective level of borate introduce a biocidally effective level of borate, thereafter relieving the excess pressure; and
(iv) removing the wood from the liquid.

The upper limit of the applicable pressure in step (ii) and (vi) mainly depends on the respective crushing strength of the wood, as collapsing of the wood should be avoided. It is preferred to apply a pressure in the range of about 50 psi to about 200 psi. Where desired, a vacuum may be applied during step (ii) and (vi) to support the efficiency of the loading.

Pesticidal wood treatments currently in use, such as CCA and ACQ, impart a color to the wood due to the nature of the metal ions present. This color also serves as a convenient indication for the consumer that the wood has been so treated. Where desired, at least one dye and/or pigment can be added to the liquid dispersions and liquid solutions of the present invention in order to impart a color to the resulting wood to serve as a similar indicator. A combination of lignin and a green pigment such as chlorinated copper phthalocyanine is particularly effective in mimicking the color of CCA-treated wood. The use of light-fugitive dyes may be particularly advantageous in this application; as the use of such dyes permits the wood to be colored for identification but, once the wood is in place in or on an outdoor structure, the exposure to sunlight will bleach the dye and the wood will revert to its natural color.

The following examples are provided to further illustrate the present invention and are not to be construed as limiting the invention in any manner.

### EXAMPLES

Preparation of Boric Acid Emulsion:

Four hundred grams of boric acid was dissolved in 9,160 grams of deionized water. 344 grams of M28B (a distilled tall oil product comprising about 28 weight-% rosin and about 72 weight-% fatty acid commercially available from MeadWestvaco Corp.), and 40 grams of Igepal CA-897 (a nonionic surfactant commercially available from Rhodia) were weighed into another container and thoroughly mixed. The boric acid solution was slowly added with stirring to the rosin-containing mixture, and the resulting emulsion was homogenized for five minutes using a Ross Model ME100L Homogenizer.

One-Step Treatment Process:

The 14″ mature southern pine sapwood board was placed inside a treating container, and immersed completely in the treating liquid containing 3200 g of a solution of boron-retaining component and the boron-containing component. The treating container was placed inside the 8″ diameter treater vessel. After the vessel was sealed, a vacuum of 22 inch Hg was applied inside the vessel for 10 minutes. Then, the vessel was filled with air and pressurized to 150 psig. The pressure was held for 20 minutes before released. The board was removed from the treating container, and the container was emptied of solution. After dried with a paper towel, the treated board placed back in the treating container which was then transferred back inside the vessel. Once the vessel was sealed, a vacuum of 25 inch Hg was drawn for 10 minutes. After releasing of the vacuum, the treated board was removed from the pan and air dried for a minimum of one week.

Two-Step Treatment Process:

(a) Pressure Treatment with Primary Treatment Solutions

The 14″ mature southern pine sapwood board was placed inside a treating container, and immersed completely in the treating liquid containing 3200 g of a solution of the boron-retaining component. The treating container was placed inside the 8″ diameter treater vessel. After the vessel was sealed, a vacuum of 22 inch Hg was applied inside the vessel for 10 minutes. Then, the vessel was filled with air and pressurized to 150 psig. The pressure was held for 20 minutes before released. The board was removed from the treating container, and the container was emptied of solution. After dried with a paper towel, the treated board placed back in the treating container which was then transferred back inside the vessel. Once the vessel was sealed, a vacuum of 25 inch Hg was drawn for 10 minutes. After releasing of the vacuum, the treated board was removed from the pan and air dried for a minimum of one week.

(b) Pressure Treatment with Secondary Treatment Solutions

The board previously treated with the primary solution was in placed inside a treating container, and immersed completely in the treating solution containing 3200 g of the boron-containing component. The treating container was placed inside the 8″ diameter treater vessel, and the same treating cycle as for the primary treatment process was applied the treater vessel. After the treatment, the treated board was removed for the vessel and air dried for a minimum of one week.

Accelerated Weathering of the Treated Board:

After one-week of drying, the treated board was attached by screws to a deck frame, and the initial boron impregnated in the treated board was determined using ICP device. The deck was then placed under a simulated condition of 90-inch of rains using a 24 hour-cycle water spray consisting of 3 hours of water spray, 3 hours of drying, 3 hours of water spray, and 15 hours of drying. The treated board was sampled weekly during the first six weeks and then every the other week from week 8 to week 14.

What is claimed is:

1. Treated wood comprising wood and borate preservative, wherein the borate preservative comprises:
(a) at least one boron-containing component, and
(b) at least one borate-retaining component selected from the group consisting of lignin-based compound, alcohol-based compound, protein, wood extract, and mixture thereof.

2. The treated wood of claim 1, wherein the borate preservative was from about 5% to 20% dry solids of the board weight.

3. The treated wood of claim 2, wherein the borate preservative was from about 15% to 20% dry solids of the board weight.

4. The treated wood of claim 1, wherein a weight ratio of the boron-component to the borate-retaining component was from about 1:1 to about 1:15.

5. The treated wood of claim 4, wherein a weight ratio of the boron-component to the borate-retaining component was from about 1:4 to about 1:10.

6. The treated wood of claim 1, wherein the boron-containing component is selected from the group consisting of organic boron compound, boric acid, boric oxide, ammonium borate, alkali metal borate, diboron tetrahydroxide, metaborate, tetraborate, octaborate, pyroborate, borane, and mixture thereof.

7. The treated wood of claim 6, wherein the organic boron compound is a borate ester.

8. The treated wood of claim 7, wherein the borate ester is selected from the group consisting of (2-methyl-2,4-pentanediol)monoborate, bis-(2-aminoethyl)borate, triethanediol diborate, tri-(2,3-dimethyl-2,3-butanediol)diborate, tri-(2,5-dimethyl-2,5-hexanediol)diborate, tri-(2,6-dimethyl-4-heptanol)borate, triethanolamine borate, tri-isopropanolamine borate, and mixture thereof.

9. The treated wood of claim 6, wherein the alkali metal borate is selected from the group consisting of sodium borate, sodium metaborate, sodium tetraborate and disodium octaborate, and mixture thereof.

10. The treated wood of claim 1, wherein the lignin-based compound is selected from the group consisting of unsulfonated lignin, sulfonated lignin, sodium salt of lignin, and mixture thereof.

11. The treated wood of claim 1, wherein the lignin-based compound is a low molecular weight, water-soluble lignin.

12. The treated wood of claim 1, wherein the alcohol-based compound is selected from the group consisting of polyvinyl alcohol, hexanediol, propyl alcohol, tannic acid, and mixture thereof.

13. The treated wood of claim 1, wherein the protein is corn zein.

14. The treated wood of claim 1, wherein the wood extract comprises organic acids, lignin, hemicellulose, terpenes, natural wax, sodium salts, and mixture thereof.

15. The treated wood of claim 14, wherein the lignin is a low-molecular weight, water soluble lignin.

16. The treated wood of claim 1, wherein the wood is a wood part.

17. The treated wood of claim 16, wherein the wood part is a member selected from the group consisting of decking, fencing, facia boards, plywood, laminated lumber, chipboard, strandboard, construction elements for outdoor furniture, and construction elements for outdoor furniture playground equipment.

18. The treated wood of claim 1, further comprising at least one member selected from the group consisting of dyes, pigments, and mixture thereof.

19. The treated wood of claim 1, wherein the wood is for exterior application.

20. The treated wood of claim 1, wherein the wood is for above ground application.

21. The method for treating wood, comprising the steps of:
(a) applying to the wood, a borate preservative comprising at least one boron-containing component and at least one borate-retaining component selected from the group consisting of lignin-based compound, alcohol-based compound, protein, wood extract, and mixture thereof, and
(b) drying the wood.

22. The method for treating wood of claim 21, wherein the boron-containing component is selected from the group consisting of organic boron compound, boric acid, boric oxide, ammonium borate, alkali metal borate, diboron tetrahydroxide, metaborate, tetraborate, octaborate, pyroborate, borane, and mixture thereof.

23. The method for treating wood of claim 22, wherein the organic boron compound is selected from the group consisting of (2-methyl-2,4-pentanediol)monoborate, bis-(2-aminoethyl)borate, triethanediol diborate, tri-(2,3-dimethyl-2,3-butanediol)diborate, tri-(2,5-dimethyl-2,5-hexanediol)diborate, tri-(2,6-dimethyl-4-heptanol)borate, triethanolamine borate, tri-isopropanolamine borate, and mixture thereof.

24. The method for treating wood of claim 22, wherein the alkali metal borate is selected from the group consisting of sodium borate, sodium metaborate, sodium tetraborate and disodium octaborate, and mixture thereof.

25. The method for treating wood of claim 21, wherein the application of the borate preservative to the wood is selected by the group consisting of pressure treating, vacuum impregnating, soaking, spraying, painting, brushing, washing, dipping, rubbing, mixing, blending, infusion and combination thereof.

26. The method for treating wood, comprising the steps of:
(i) immersing wood in a liquid containing a borate-preservative, wherein the borate preservative comprises:
(a) at least one boron-containing component, and
(b) at least one borate-retaining component selected from the group consisting of lignin-based compound, alcohol-based compound, protein, wood extract, and mixture thereof; and
(ii) loading the immersed wood with the liquid under excess pressure for a period of time sufficient to impregnate the wood with a biocidally effective level of borate introduce a biocidally effective level of borate, thereafter relieving the excess pressure; and
(iii) removing the wood from the liquid.

27. The method for treating wood of claim 26, wherein the boron-containing component is selected from the group consisting of organic boron compound, boric acid, boric oxide, ammonium borate, alkali metal borate, diboron tetrahydroxide, metaborate, tetraborate, octaborate, pyroborate, borane, and mixture thereof.

28. The method for treating wood of claim 27, wherein the organic boron compound is selected from the group consisting of (2-methyl-2,4-pentanediol)monoborate, bis-(2-aminoethyl)borate, triethanediol diborate, tri-(2,3-dimethyl-2,3-butanediol)diborate, tri-(2,5-dimethyl-2,5-hexanediol)diborate, tri-(2,6-dimethyl-4-heptanol)borate, triethanolamine borate, tri-isopropanolamine borate, and mixture thereof.

29. The method for treating wood of claim 27, wherein the alkali metal borate is selected from the group consisting of sodium borate, sodium metaborate, sodium tetraborate and disodium octaborate, and mixture thereof.

30. The method for treating wood of claim 26, wherein a vacuum is applied during step (ii).

31. The method for treating wood of claim 26, wherein a pressure in the range of about 50 psi to about 200 psi is applied in step (ii).

32. The method for treating wood, comprising the steps of:
(i) immersing wood in a liquid containing at least one borate-retaining component selected from the group consisting of lignin-based compound, alcohol-based compound, protein, wood extract, and mixture thereof;
(ii) loading the immersed wood with the liquid under excess pressure;
(iii) removing the wood from the liquid;
(iv) air-drying the wood;
(v) immersing the wood in a liquid containing at least one boron-containing component;
(vi) loading the immersed wood with the liquid under excess pressure for a period of time sufficient to impregnate the wood with a biocidally effective level of borate introduce a biocidally effective level of borate, thereafter relieving the excess pressure; and
(vii) removing the wood from the liquid.

33. The method for treating wood of claim 32, wherein the boron-containing component is selected from the group consisting of organic boron compound, boric acid, boric oxide, ammonium borate, alkali metal borate, diboron tetrahydroxide, metaborate, tetraborate, octaborate, pyroborate, borane, and mixture thereof.

34. The method for treating wood of claim 33, wherein the organic boron compound is selected from the group consisting of (2-methyl-2,4-pentanediol)monoborate, bis-(2-aminoethyl)borate, triethanediol diborate, tri-(2,3-dimethyl-2,3-butanediol)diborate, tri-(2,5-dimethyl-2,5-hexanediol)diborate, tri-(2,6-dimethyl-4-heptanol)borate, triethanolamine borate, tri-isopropanolamine borate, and mixture thereof.

35. The method for treating wood of claim 33, wherein the alkali metal borate is selected from the group consisting of sodium borate, sodium metaborate, sodium tetraborate and disodium octaborate, and mixture thereof.

36. The method for treating wood of claim 32, wherein a vacuum is applied during step (ii) and (vi).

37. The method for treating wood of claim 32, wherein a pressure in the range of about 50 psi to about 200 psi is applied in step (ii) and (vi).
